(19) United States
(12) Patent Application Publication
(10) Pub. No.: US 2017/0329067 A1
(43) Pub. Date: Nov. 16, 2017

(54) Novel Nightlight Having a Simple Structure

(71) Applicant: ZhongShan Winstar Electrical Co., Ltd., Zhongshan (CN)

(72) Inventors: Yu Li, Zhongshan (CN); Nan Chun Chen, Zhongshan (CN); Feng Du, Zhongshan (CN); Hui Liang Xin, Zhongshan (CN)

(21) Appl. No.: 15/213,365

(22) Filed: Jul. 18, 2016

(30) Foreign Application Priority Data
May 14, 2016 (CN) 201620441549.9

(51) Int. Cl. F21V 8/00; F21L 4/02; F21L 4/08; F21W 131/30

(52) U.S. Cl. CPC G02B 6/0021; G02B 6/0093; G02B 6/0088; G02B 6/0083; G02B 6/0055; F21L 4/02; G02B 6/0026; G02B 6/0035; F21L 4/08; F21W 2131/3005

(57) ABSTRACT

The present invention discloses a novel nightlight with a simple structure. A non-opaque light output panel is disposed on a casing. A plurality of first lamp beads is directly welded onto a control circuit board. The light emitted by the first lamp beads is guided into a light output panel after refracting or reflecting by a light guide member, which facilitates transmission of light and allows uniform and soft light outputted from the light output panel. The nightlight has the advantages of convenient use, easy manufacture and assembly and low manufacturing cost.

### CROSS-REFERENCE TO RELATED APPLICATIONS

The present application claims the benefit Chinese Patent Application No. 201620441549.9 filed on May 14, 2016, the entire content of which is hereby incorporated by reference.

### TECHNICAL FIELD OF THE INVENTION

The present invention relates to lighting devices, and more particularly, to a novel nightlight having a simple structure.

### BACKGROUND OF THE INVENTION

In the market, there are many kinds of nightlights. The brightness of ordinary nightlights is high and not even. During use, they are liable to generating dazzling, affecting the eyes of users. Furthermore, they have many parts, rendering complicated manufacture and high cost of manufacture of these lights. In addition, the lamp beads of an ordinary nightlight are separate from the control circuit board, but electrically connected to the control circuit board through wires, which may cause a phenomenon of unstable electrical contact when they are used in an impact environment. Also the manufacture cost of these nightlights is high.

The present invention is researched and directed to address the defects in prior art.

### SUMMARY OF THE INVENTION

The object of the present invention is to overcome the defects in prior art, providing a novel nightlight having the advantages of simple structure, uniform light output, stable electrical contact, convenient manufacture and assembly with low cost.

The present invention solves the foregoing technical problems by the following technical solutions.

The present invention provides a novel nightlight having a simple structure comprising a casing in which a control circuit board is disposed; wherein a plurality of first lamp beads is electrically connected to the control circuit board, and the casing is provided with a non-opaque light output panel and a light guide member that can import the light emitted by the first Lamp beads into the light output panel and emit the light.

According to the present invention, a concave light guide groove is disposed at one end of the light guide member, and the first lamp beads are located in the light guide groove.

According to the present invention, the light guide member is a light guide sleeve or a light guide column, in which the light guide groove is disposed at the bottom of one end of the light guide sleeve or the light guide column. Further, the first Lamp beads are connected and distributed in a ring shape, and the light guide groove is a circular groove corresponding to the first lamp beads.

Preferably, the first lamp beads are disposed on the control circuit board.

Preferably, the casing comprises a lower casing and an upper cover, in which the light output panel is connected to the upper cover in a snapped manner.

Preferably, the light guide member is a stepped axle sleeve. A limiting counter bore matching the stepped axle sleeve is disposed on the upper cover.

Further, the light guide member is provided with a plurality of positioning holes, and a decorating member matching the light guide member is disposed on the light output panel, in which positioning pins matching the positioning holes are disposed on the decorating member.

Preferably, the control circuit board is electrically connected to an inductive switch that passes through the light guide member and is used for controlling inductively the illumination of the first lamp beads.

Preferably, a second lamp bead electrically connected to the control circuit board is disposed at one end of the casing, and wherein the casing is provided with a reflection cup shaped as a cone and disposed at the end of the casing for covering the second lamp bead and a terminal light guide plate disposed at the end of the casing for blocking light output port of the reflection cup.

Preferably, an inner side of the terminal light guide plate is provided with a terminal light adjusting structure for evenly radiating the light generated by the second lamp bead.

Comparing the existing technology, the present invention can bring about the following benefits and advantages:

1. A non-opaque light output panel is disposed on the casing and the light guide member may be a light guide sleeve or a light guide column. The light emitted by the first lamp beads is guided into the light output panel through refraction or reflection by the light guide member, which facilitates transmission of light and allows output of uniform and soft light from the light output panel.
2. A concave light guide groove is disposed at one end of the light guide member in which the first lamp beads are located, so that more light emitted from the first lamp beads can enter into the light guide member and is subsequently imported to the light output panel via the light guide member to assure the brightness of outputted light and reduce consumption of light energy.
3. The first lamp beads are connected and distributed in a ring shape and the light guide groove is a circular groove corresponding to the first lamp beads, allowing output of uniform and soft light to avoid dazzling effectively.
4. The first lamp beads are directly welded onto the control circuit board, which may cause the nightlight having a simple structure and stable electrical contact, simplify manufacture and assembly process, increase productivity and lower manufacture cost.
5. The casing comprises a lower casing and an upper cover. The light output panel is connected to the upper cover, allowing convenience of manufacture, assembly, connection, disassembly and replacement of the nightlight, which may increase productivity and lower manufacture cost.
6. A decorating member matching the light guide member is disposed on the light output panel. The decorating member plays a certain role in reflecting the light emitted from the light guide member, rendering more uniform output of light and meanwhile improvement of the appearance thereof.
7. An inductive switch passing through the light guide member is electrically connected to the control circuit board, and is used for controlling inductively the illumination of the first lamp beads, by which the inductive switch automatically detects movement of human body to illuminate the first lamp beads so that automatic control of the nightlight can be realized for convenience of use.
8. A second lamp bead and a reflection cup covering the second lamp bead are disposed at the end of the casing. A terminal light guide plate connected to the end of the casing in snapped manner is disposed at the light output port of the reflection cup. A terminal light adjusting structure is disposed on the inner side of the terminal light guide plate. The terminal light adjusting structure comprises convex points on inner side of the terminal light guide plate, and each convex point has a curved face or an inclined plane so that the light generated by the second lamp bead is exported from the terminal light guide plate after being refracted and reflected by the surface of the convex point, causing the light outputted uniform and soft. It may be used as lighting of a torch and is convenient for use.

### BRIEF DESCRIPTION OF THE DRAWINGS

FIG. 1 is one schematic view of the present invention;

FIG. 2 is another schematic view of the present invention;

FIG. 3 is an exploded view of the present invention;

FIG. 4 is sectional view of the present invention taken as A-A;

FIG. 5 is a schematic view of a light guide member of the present invention, which is a light guide sleeve;

FIG. 6 is a schematic view of a light guide member of the present invention, which is a light guide column;

FIG. 7 is a schematic view of a decorating member of the present invention;

FIG. 8 is a schematic view of a terminal light guide plate of the present invention;

FIG. 9 is a schematic view of an upper cover of the present invention; and

FIG. 10 is a schematic view of the body of the upper cover of the present invention.

### DETAILED DESCRIPTION OF THE INVENTION

The following description made with reference to the accompanying drawing is given by way of non-limiting example and makes it easy to understand what the invention consists in and how it can be implemented.

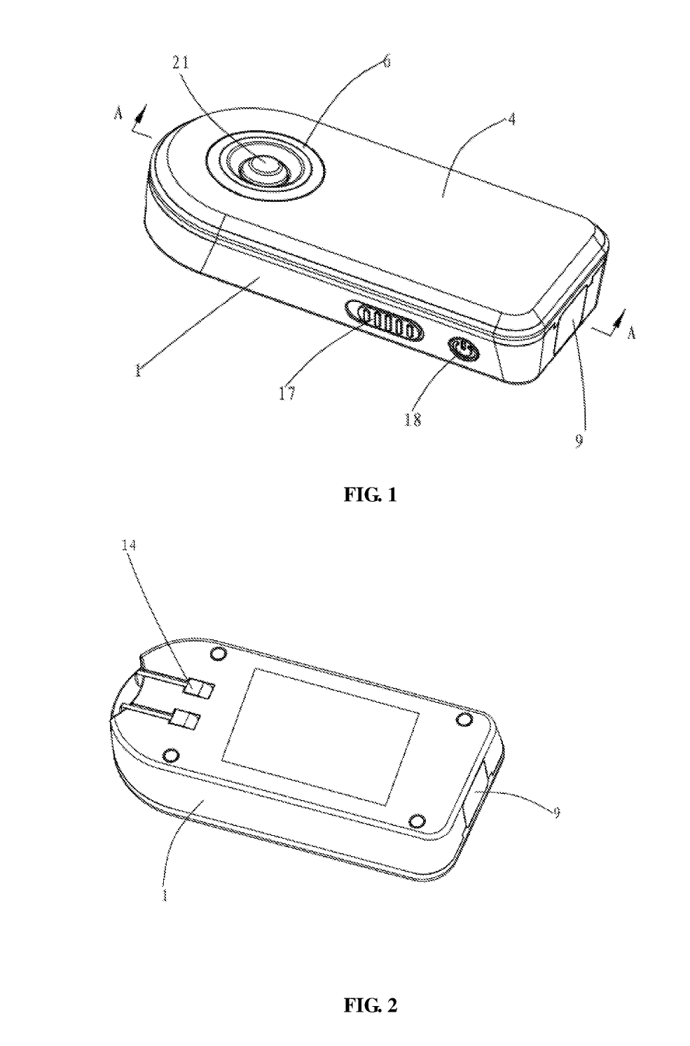

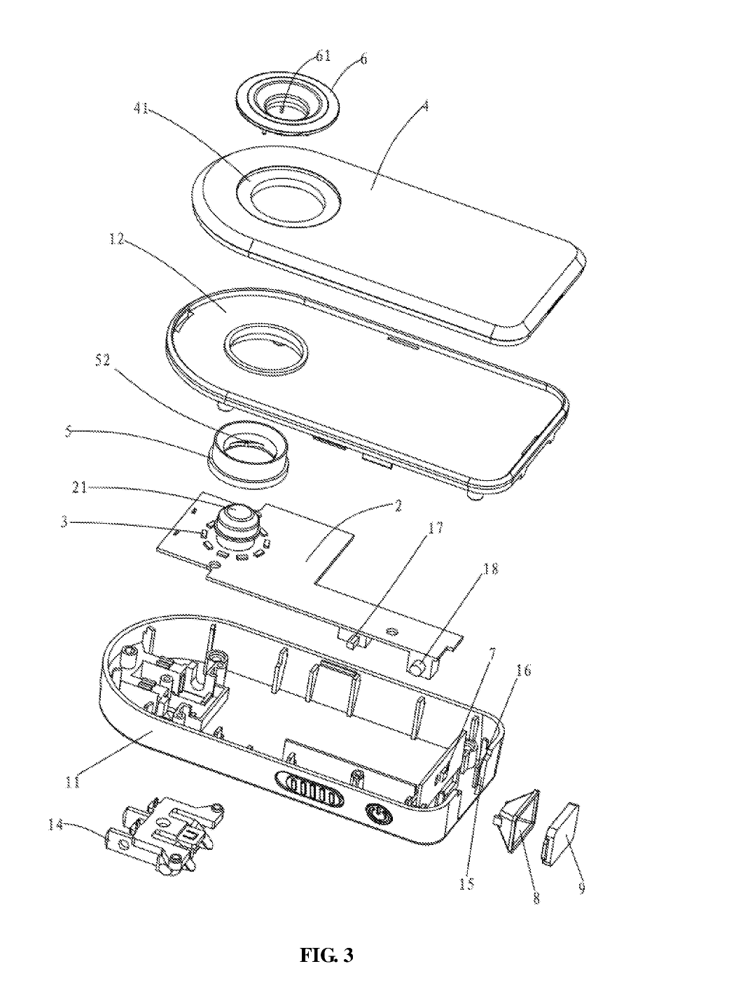

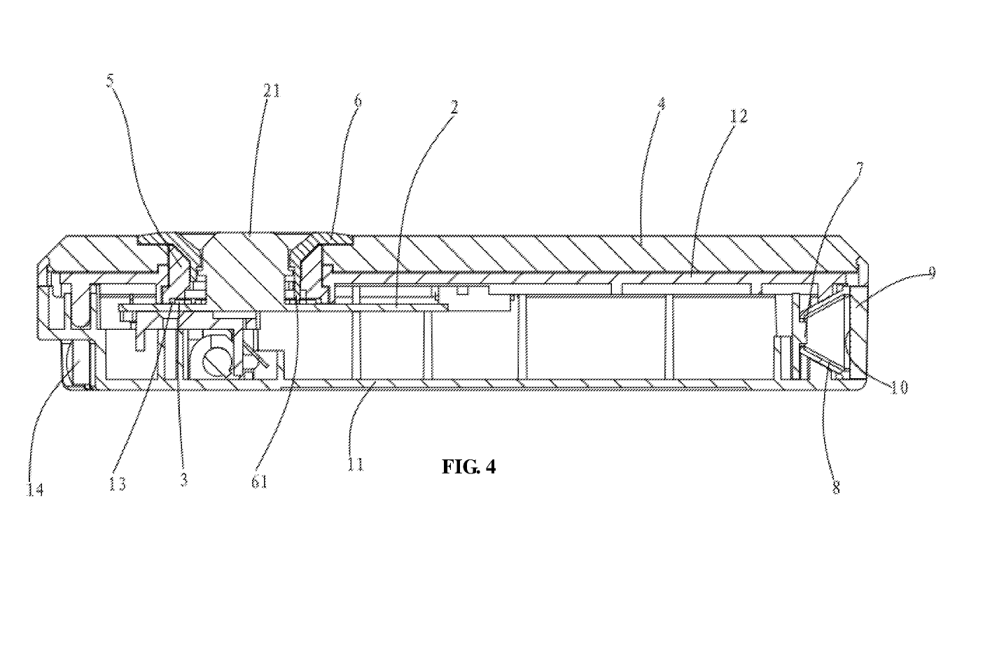

Referring to FIG. 1˜FIG. 4, a novel nightlight having a simple structure is provided by the present invention. The nightlight comprises a casing 1 in which a control circuit board 2 is disposed. A plurality of first lamp beads 3 is electrically connected to the control circuit board 2, i.e.: the first lamp beads 3 are directly welded onto the control circuit board 2 to assure stable electrical contact, simplify manufacture and assembly process, increase productivity and lower manufacture cost. The casing 1 comprises a non-opaque light output panel 4, and the casing 1 is also provided with a light guide member 5 that can import the light emitted by the first lamp beads 3 into the light output panel 4. The light emitted by the first lamp beads 3 is imported to the light output panel 4 via refraction or reflection by the light guide member 5, allowing that the light is outputted from the light output panel uniformly and softly.

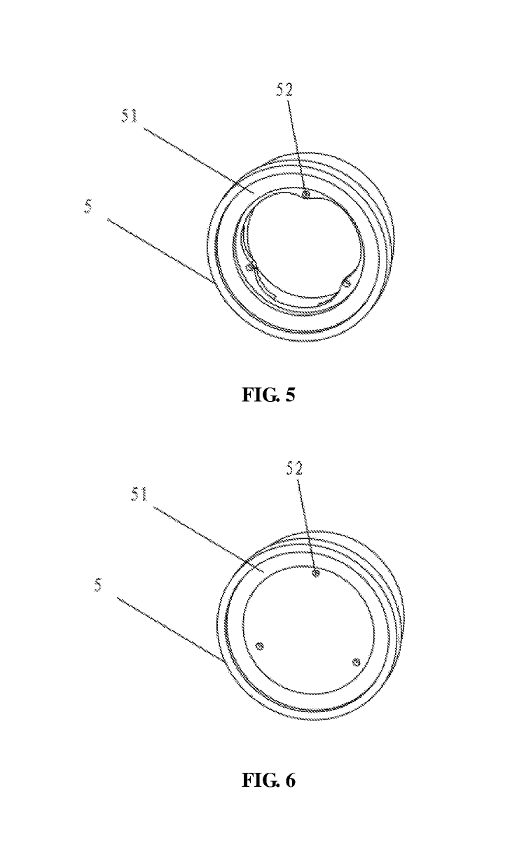

As shown in FIG. 5, the light guide member 5 can be a light guide sleeve. As shown in FIG. 6, the light guide member 5 can be a light guide column. A light guide groove 51 is disposed at the bottom of one end of the light guide sleeve or the light guide column. The light guide groove 51 can be a circular groove corresponding to the first lamp beads 3 and is used for receiving the first lamp beads 3, in which the first lamp beads 3 can be LED lamp beads that are connected in a ring shape. When the first lamp beads 3 is illuminated, more light entering into the light guide member 51 and guiding into the light output panel 4 via the light guide member 51 can be guaranteed, which assure brightness of the light outputted and reduce loss of light energy.

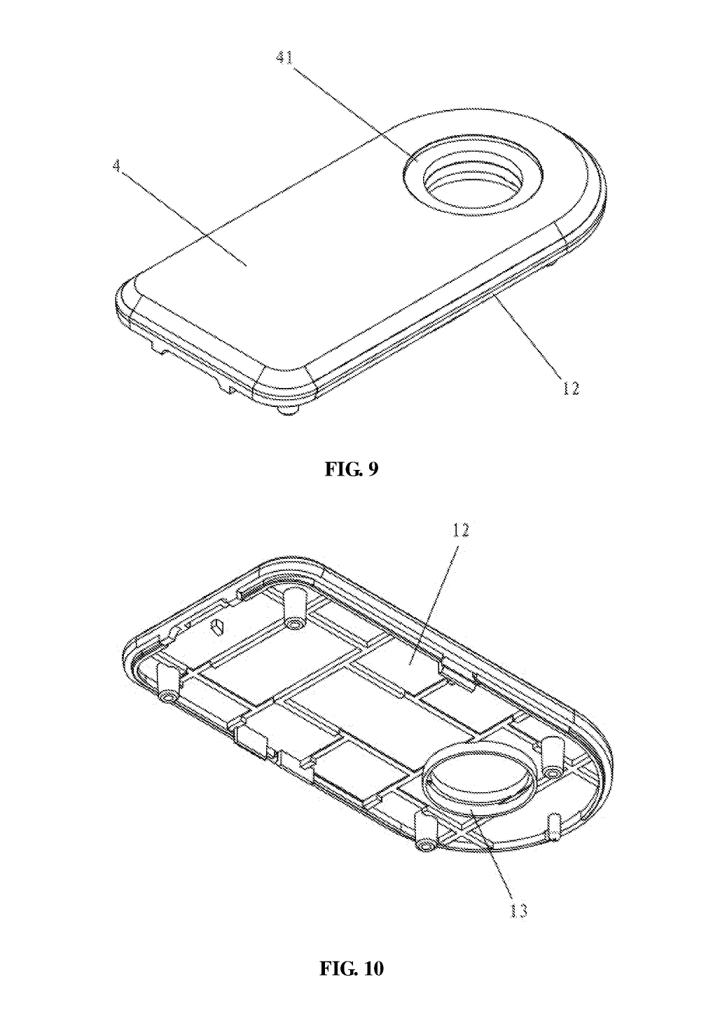

As shown in FIG. 9 and FIG. 10, the casing 1 comprises a lower casing 11 and an upper cover 12. The light output panel 4 is connected to the upper cover 12 in a snapped manner. In order to improve brightness and lower loss of light energy, a reflective layer is employed on the upper surface of the upper cover 12 to further improve light output efficiency.

When a light guide sleeve is used as the light guide member 5, it can be a stepped axle sleeve, and a limiting counter bore 13 matching the stepped axle sleeve is disposed on the upper cover 12.

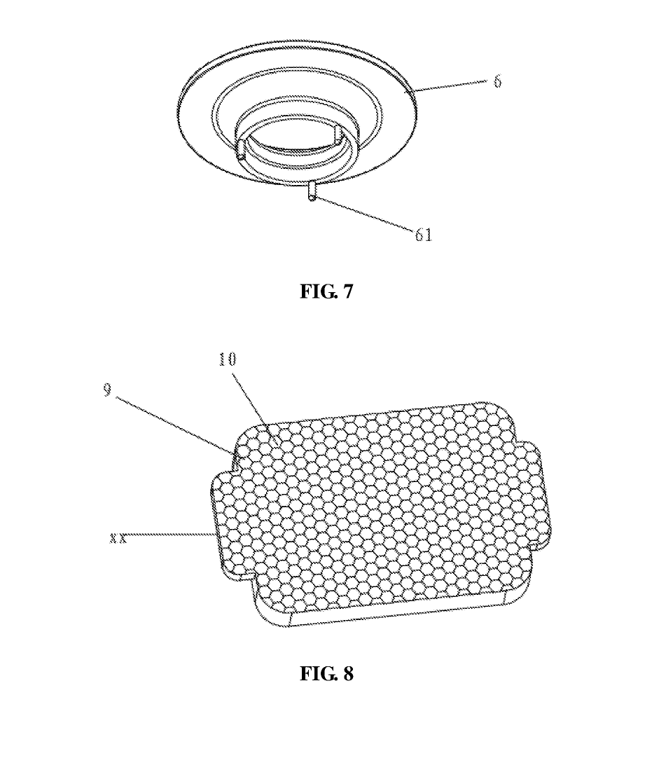

A plurality of positioning holes 52 is disposed at the end of the light guide member 5. As shown in FIG. 7, a decorating member 6 is disposed on the light output panel 4, and a plurality of positioning pins 61 matching the positioning holes 52 is also disposed on the decorating member 6. The positioning pins 61 are fixedly inserted into the positioning holes 52 correspondingly. A cover counter bore 41 in which the upper part of the decorating member 6 is inlaid is disposed on the front of the light output panel 4.

An inductive switch 21 passing through the light guide member 5 and controlling inductively the illumination of the first lamp beads 3 is electrically connected to the control circuit board 2, by which automatic detection of movement of human body to illuminate the first lamp beads can be realized.

A second lamp bead 7 electrically connected to the control circuit board 2 is disposed in one end of the casing 1. A reflection cup 8 with a conical structure for covering the second lamp bead 7 is also disposed in one end of the casing 1. The reflection cup 8 can be shapes as a pyramid. A terminal light guide plate 9 for blocking the light output port of the reflection cup 8 is disposed at one end of the casing 1, on inner side of which is provided with a terminal light adjusting structure 10 for evenly radiating the light generated by the second lamp bead 7. As shown in FIG. 8, the terminal light adjusting structure 10 comprises convex points in a matrix form, each of which has a curved face or an inclined plane.

A terminal light output port 15 is disposed at one end of the casing 1. A slot 16 is oppositely disposed on the inner side of the terminal light output port 15. Plug pins 17 connected to the slot 16 in an inserted manner are disposed on two sides of the terminal light guide plate 9.

On the side of the casing 1, a first switch 17 controlling the first lamp beads 3 and a second switch 18 controlling the second lamp bead 7 are provided. A battery 19 is disposed in the casing 1. A foldable plug 14 electrically connected to the control circuit board is disposed on the casing 1. During use, the plug 14 is pulled out and plugged into a socket to supply power and recharge the battery. After the plug 14 is pulled out from the socket, it may be folded and laid into the casing 1. When the first switch 17 is connected, the first lamp beads 3 can be illuminated. The light is imported to the light output panel 4 via the light guide member 5 so as to evenly emit the light from the output panel 4. When the second switch 18 is connected, the second lamp bead 7 can be illuminated. The light emitted from the second lamp bead 7 enters into the terminal light guide plate 9 through reflection and radiation of the reflection cup 8, followed by adjustment by the terminal light adjusting structure 10 on the terminal light guide plate 9 to evenly emit the light.

What is claimed is:

1. A novel nightlight having a simple structure comprising a casing in which a control circuit board is disposed; wherein a plurality of first lamp beads is electrically connected to the control circuit board, and the casing is provided with a non-opaque light output panel and a light guide member that can import the light emitted by the first Lamp beads into the light output panel and emit the light.

2. The novel nightlight having a simple structure according to claim 1, wherein a concave light guide groove is disposed at one end of the light guide member, and the first lamp beads are located in the light guide groove.

3. The novel nightlight having a simple structure according to claim 2, wherein the light guide member is a light guide sleeve or a light guide column, in which the light guide groove is disposed at the bottom of one end of the light guide sleeve or the light guide column;
and wherein the first Lamp beads are connected and distributed in a ring shape, and the light guide groove is a circular groove corresponding to the first lamp beads.

4. The novel nightlight having a simple structure according to claim 1, wherein the first lamp beads are disposed on the control circuit board.

5. The novel nightlight having a simple structure according to claim 1, wherein the casing comprises a lower casing and an upper cover, in which the light output panel is connected to the upper cover in a snapped manner.

6. The novel nightlight having a simple structure according to claim 5, wherein the light guide member is a stepped axle sleeve, and a limiting counter bore matching the stepped axle sleeve is disposed on the upper cover.

7. The novel nightlight having a simple structure according to claim 5, wherein the light guide member is provided with a plurality of positioning holes, and a decorating member matching the light guide member is disposed on the light output panel, in which positioning pins matching the positioning holes are disposed on the decorating member.

8. The novel nightlight having a simple structure according to claim 1, wherein the control circuit board is electrically connected to an inductive switch that passes through the light guide member and is used for controlling inductively the illumination of the first lamp beads.

9. The novel nightlight having a simple structure according to claim 1, wherein a second lamp bead electrically connected to the control circuit board is disposed at one end of the casing, and wherein the casing is provided with a reflection cup shaped as a cone and disposed at the end of the casing for covering the second lamp bead and a terminal light guide plate disposed at the end of the casing for blocking light output port of the reflection cup.

10. The novel nightlight having a simple structure according to claim 9, wherein an inner side of the terminal light guide plate is provided with a terminal light adjusting structure for evenly radiating the light generated by the second lamp bead.
